(19) United States
(12) Patent Application Publication
(10) Pub. No.: US 2011/0042197 A1
(43) Pub. Date: Feb. 24, 2011

(54) PIGGYBACK PLUG MODULE FOR A SWITCH

(75) Inventors: Stephan Koll, Schaffhausen (CH); Patrick Kemna, Schaffhausen (CH)

Correspondence Address: BACHMAN & LAPOINTE, P.C., 900 CHAPEL STREET, SUITE 1201, NEW HAVEN, CT, 06510, US

(73) Assignee: BIRCHER REGLOMAT AG, Beringen (CH)

(21) Appl. No.: 12/858,502

(22) Filed: Aug. 18, 2010

(30) Foreign Application Priority Data
Aug. 18, 2009 (DE) 10 2009 037 800.6

(51) Int. Cl. H01H 1/58

(52) U.S. Cl. 200/51 R

(57) ABSTRACT

A piggyback plug module (1) for a switch, in particular for a pneumatic switch, having at least two contacts (10) for in each case one electrically conductive connection to a respective connecting contact of the switch; a connection (11) for a connection cable, wherein the contacts (10) are connected to the connection (11), and a functional device (13) held in the piggyback plug module (1).

### BACKGROUND OF THE INVENTION

The present invention relates to a piggyback plug module for a switch, in particular for a pneumatic switch, having at least two contacts for in each case one electrically conductive connection to a respective connecting contact of the switch, and a connection for a connection cable, wherein the contacts are connected to the connection cable.

The prior art is designed such that a switch is connected via a connecting element to other devices, and complete replacement is necessary when the user wishes to have a different function.

The object of the invention is to provide a concept which is as flexible as possible and which can be used for switches of widely different types and designs, as well as methods of operation. A further aim is to achieve a user-friendly split and application, which are simple to handle, with the aim of overcoming or at least reducing the disadvantages of the prior art, and in particular, the apparatus should be of simple design and should be advantageous to operate, with the aim of achieving a major improvement in flexible usefulness.

### SUMMARY OF THE INVENTION

The object is achieved by a piggyback plug module having at least two contacts for, in each case, one electrically conductive connection to a respective connecting contact of the switch, as well as a connection for a connection cable, wherein the contacts are connected to the connection.

The piggyback plug module according to the invention has the advantage that a functional device is held integrated in the piggyback plug module. This integrated functional device allows the user to make use of different functional devices, and therefore piggyback plug modules, depending on the desired functionality of the piggyback plug module.

The piggyback plug modules are preferably designed such that they can be distinguished from one another by color, and therefore have a feature which can be seen from the outside, depending on the functionality. The respective functional device provided in the piggyback plug module can likewise be identified by an inscription or marking on the piggyback plug module.

The user can then connect the piggyback plug module to the switch, in particular to a pneumatic switch, depending on the desired functionality, and can thus use the functional device located in the respective piggyback plug module.

In this context, it is particularly preferable to design a connection with a plug which is best in the form of a replaceable module. This would have the advantage that different plugs could be connected to the piggyback plug module. The material, shape and configuration are governed by the user's requirements, and can be designed completely differently.

The contacts are used to connect the piggyback plug module to the switch as easily as possible. The piggyback plug module furthermore has an indicator for indicating a switching state of the switch. This indicator results in the advantage that the user can immediately tell whether the desired function is or is not in use at the time when he looks at it. This makes it possible to search for problem faults easily and in a user-friendly manner.

The functional device is designed such that information or signals received from the switch can be changed, processed further and monitored. The functional device which is integrated in the piggyback plug module has the advantage that the information and signals can be changed, reprocessed and passed on flexibly and variably by combined use of different piggyback plug modules and functional devices.

In addition to the functional device, a memory is also integrated in the piggyback plug module. This memory is used to store signals and information. The separate arrangement of the memory and switch has the advantage that the memory can be removed from the switch in the form of the piggyback plug module, in order to ensure that the information and signals can be read more easily. This results in the advantage that there is no longer any need to lay long data lines from the piggyback plug module and switch to an assessment and reading unit.

The contacts are designed such that the piggyback plug module can be plugged onto the switch, with the contacts being connected to the connecting contacts. In this case, it is irrelevant whether the contacts project into the connecting contacts or, conversely, the connecting contacts project into the contacts. The desired advantage is just simple contact being made, in a manner such that contact is made more or less at the same time, between the contacts and the connecting contacts when the switch is connected to the piggyback plug module. An arrangement of contacts and connecting contacts based on the lock-and-key principle has the advantage that the piggyback plug module and the switch can be connected and disconnected easily and quickly.

Furthermore, the piggyback plug module is designed such that it has a power supply which is designed to draw power for supplying the functional device from the connection of the contacts to the connection. This has the advantage that a power supply such as this means that there is no need to arrange an additional energy source in the piggyback plug module, which on the one hand would limit the function/life of the piggyback plug module, and could also represent a fault source. The provision of a power supply such as this also has the advantage that the indicator could likewise be fed from the same power supply and, in the event of an appropriate indication, the user would also be able to tell whether the functional device and memory have sufficient power or not.

The piggyback plug module is also intended to have an energy store for storing electrical energy. This energy store is fed by the power supply. The advantage of an energy store such as this is that, when the piggyback plug module is disconnected from the conventional power supply, the memory and functional device will nevertheless still operate. A further advantage is that stored data is thus not lost. The energy store should be designed such that the functional device and the memory can operate for as long as possible without the power supply.

The contacts are electrically conductively connected to the connecting contacts. This can also be interrupted and connected via a circuit, without disconnecting the piggyback plug module and the switch.

Furthermore, the piggyback plug module according to the invention preferably has latching tabs which make the connection between the piggyback plug module and the switch. In this case, in the first instance, it is irrelevant whether the latching tabs are fitted to the piggyback plug module and the recesses to the switch, or the latching tabs are fitted to the switch and the corresponding recesses to the piggyback plug module. This connection has the advantage that the piggyback plug module and switch can be connected and released easily. Furthermore, the user can detect or hear corresponding latching-in when the latching tabs are latched into the corresponding recesses or openings. This provides further assurance that a firm connection has been made.

A further independent subject matter of the invention is a method according to the other independent claim. An advantageous method is distinguished in that an indication of a switching state of the switch, the change in a signal from the switch, storage of a signal from the switch or energy being drawn from a circuit which is closed by the switch is monitored, with a connecting line being supplied via the contacts. This has the advantage that the monitoring of the functional state of the piggyback plug module is assured and can be carried out easily and cost-effectively.

Galvanic isolation is preferably implemented and formed between the circuit or contacts and the circuit of the connecting element.

### BRIEF DESCRIPTION OF THE DRAWINGS

The invention will be explained in more detail with reference to attached drawings, where, in the drawings:

FIG. 1 shows a schematic side view of a piggyback plug module according to the invention;

FIG. 2 shows a partially sectioned view of the piggyback plug module as shown in FIG. 1;

FIG. 3 shows an approximately half-section view of the piggyback plug module as shown in FIG. 1.

### DETAILED DESCRIPTION

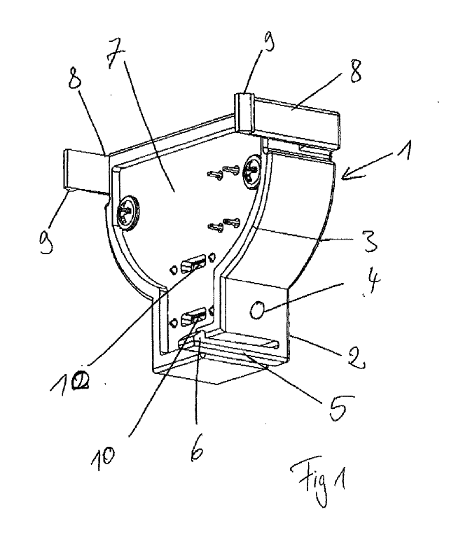

FIG. 1 shows a piggyback module 1 according to the invention in the form of a schematic view obliquely from the side and from underneath. The piggyback plug module 1 of FIG. 1 is intended to be plugged onto a switch which is not shown here, in particular a pneumatic switch. Overall, the piggyback plug module 1 has a cap 2 which is integrally connected to a semicircular structure 3. An indicator 4 can be seen in the cap 2. In addition, the cap 2 has a web 5 under the indicator 4. One side of the web 5 is connected in the form of half an arc to the cap 2. The other end of the web 5 has a latching tab 6.

In addition, FIG. 1 shows a wall 7. The wall 7 is connected to the piggyback plug module 1 via two screws, which will not be described in any more detail.

The structure 3 has two further webs 8, each with latching tabs 9 at the end.

Furthermore, two openings, in which contacts 10 are provided, can be seen in the wall 7.

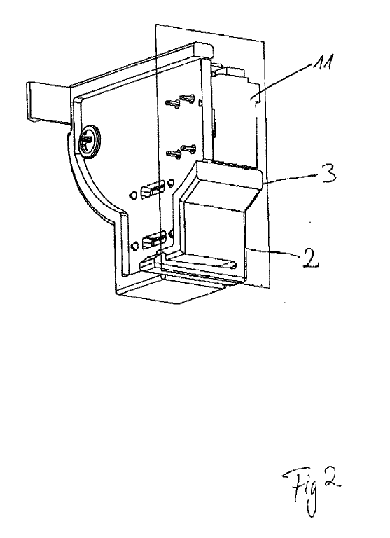

FIG. 2 shows a connection 11 on the structure 3.

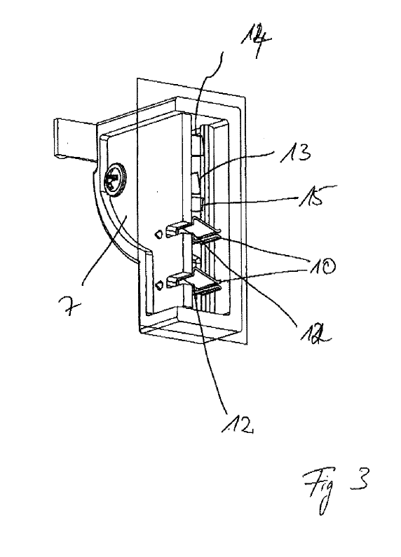

The contacts 10 can be seen better in FIG. 3 and have a rectangular inlet 12 at one end. The contacts are designed such that they run closely together opposite the inlet 12. In addition FIG. 3 shows a functional device 13, as well as a memory 14, and also shows an energy store 15. The functional device 13, the memory 14, the energy store 15 and the contacts 10 are connected to the connection 11 by means of electrical lines, which will not be described in any more detail.

In addition, an energy store 15 can be seen in the interior of the piggyback plug module 1 and is used to supply electrical power to the functional device and memory when the piggyback plug module 1 has been disconnected from the power supply via the connection 11.

1. Piggyback plug module (1) for a pneumatic switch, comprising:
(a) at least two contacts (10) for in each case one electrically conductive connection to a respective connecting contact of the switch; and
(b) a connection (11) for a connection cable, wherein the contacts (10) are connected to the connection (11), wherein a functional device (13) is held in the piggyback plug module (1).

2. Piggyback plug module according to claim 1, wherein the functional device (13) has an indicator (4) for indicating a switching state of the switch.

3. Piggyback plug module according to claim 1, wherein the functional device (13) changes a signal received from the switch via the contacts (10).

4. Piggyback plug module according to claim 1, wherein the functional device (13) has a memory (14) which stores a signal received from the switch via the contacts (10).

5. Piggyback plug module according to claim 1, wherein the contacts (10) are designed such that the piggyback plug module (1) can be plugged onto the switch, with the contacts (10) being connected to the connecting contacts.

6. Piggyback plug module according to claim 1, wherein the piggyback plug module (1) has a power supply which is designed to draw power for supplying the functional device (13) from the connection of the contacts (10) to the connection (11).

7. Piggyback plug module according to claim 1, further including an energy store (15) for storing electrical energy.

8. Piggyback plug module according to claim 1, wherein the contacts (10) are electrically conductively connected to the connecting contacts.

9. Piggyback plug module according to claim 1, further including a housing, wherein the housing has latching tabs (6, 9) for connection to the pneumatic switch.

10. Piggyback plug module according to claim 1, further including a circuit for lengthening the arc.

11. A method for monitoring a switch having a piggyback plug module (1) according to claim 1, comprising an indication of a switching state of the switch.

12. A method according to claim 11, including changing a signal from the switch.

13. A method according to claim 12, including storing of the signal from the switch.

14. A method according to claim 11, including drawing energy from a circuit which is closed by the switch.
